(19) United States
(12) Patent Application Publication
(10) Pub. No.: US 2025/0370084 A1
(43) Pub. Date: Dec. 4, 2025

(54) COOPERATIVE MULTI-NODE POSITIONING

(71) Applicant: Huawei Technologies Co., Ltd., Shenzhen (CN)

(72) Inventors: Ahmed Wagdy Abdelwahab Shaban, Kanata (CA); Shahram Shahsavari, Ottawa (CA); Alireza Bayesteh, Brossard (CA); Jianglei Ma, Ottawa (CA)

(21) Appl. No.: 19/297,471

(22) Filed: Aug. 12, 2025

Related U.S. Application Data
(63) Continuation of application No. PCT/CN2023/076623, filed on Feb. 16, 2023.

(51) Int. Cl. G01S 5/02; G01S 5/00; G01S 5/08

(52) U.S. Cl. CPC G01S 5/0273; G01S 5/0036; G01S 5/08

(57) ABSTRACT

In general, aspects relate to cooperation between a main transmit-receive point (TRP) and some helping nodes. The helping nodes transmit a copy of the sensing signal after manipulating time-frequency-spatial properties of a received version of the sensing signal. That is, upon receiving, from the main TRP, the sensing signal, a helping node may alter the sensing signal, for example by delaying the sensing signal in time and shifting the sensing signal in frequency, before transmitting the altered sensing signal to a target UE or other sensing receiver.

### CROSS-REFERENCE TO RELATED APPLICATIONS

This application is a continuation of International Application No. PCT/CN2023/076623, filed Feb. 16, 2023, which is incorporated herein by reference in its entirety.

### TECHNICAL FIELD

The present disclosure relates, generally, to positioning in wireless communication systems and, in particular embodiments, to positioning that relies upon cooperation between multiple nodes.

### BACKGROUND

Interest in the integration of positioning functionalities into communication systems may be shown to have recently had an exponential growth. The interest may be shown to have started decades ago, when communication systems could provide only very coarse position information. The coarse position information was used, for example, for emergency calls.

It is envisioned that the interest in the integration of positioning functionalities into communication systems will continue. Next steps include the integration of fully-fledged and independent positioning services into communication systems.

In currently operational cellular communication systems, such as fifth generation (5G) wireless communication systems, position information is known to play a central role in enhancing the performance of most of the communication functions and their associated procedures. Procedures that are known to be enhanced by position information include initial access procedures, beam training procedures, alignment procedures, resource allocation procedures, channel training procedures and channel estimation procedures.

In-development wireless communication systems may be refenced as “beyond 5G” communication systems or sixth generation (6G) communication systems. In the in-development wireless communication systems, high-accuracy and low-latency positioning may be shown to be a so-called key enabler technology for various use cases and applications. These use cases and applications include intelligent transportation systems, vehicular to everything systems, connected robotics systems, drone systems and autonomous systems. These use cases and applications have in common that position information may be acquired as an independent service.

### SUMMARY

In general, aspects of the present application relate to cooperation between a main Transmit-Receive Point (TRP) and some helping nodes. The cooperation allows for creation of multiple copies of a sensing signal from the main TRP. The helping nodes transmit a copy of the sensing signal after manipulating time-frequency-spatial properties of a received version of the sensing signal. The manipulating may use radio frequency (RF) operations that are known to be low-complexity, low-latency and cheap. That is, upon receiving, from the main TRP, the sensing signal, a helping node may alter the sensing signal, by, say, delaying the sensing signal in time and shifting the sensing signal in frequency, before transmitting the altered sensing signal to a target UE. Since the time manipulations and frequency manipulations are only limited to predefined shifts in the RF domain, these manipulations do not change an original time reference point or an original frequency reference point of the sensing signal.

Conveniently, those aspects of the present application that relate to a positioning procedure may be shown to lack of synchronization error.

It may be shown that any enhancement of accuracy in positioning procedures facilitates other communication procedures, such as procedures related to channel training and estimation and procedures related to beam management. The enhancement of accuracy in positioning procedures may be shown to enable efficient management and optimization of network resources based on position information.

One advantage of positioning procedures representative of aspects of the present application is an elimination of TRP-side synchronization error. Aspects of the present application utilize a node-specific process-and-forward transmission strategy. It may be shown that the nodes do not introduce synchronization error to the time measurements of the positioning procedures representative of aspects of the present application.

Another advantage of positioning procedures representative of aspects of the present application is a relatively low signaling overhead. Aspects of the present application relate to transmission of a single sensing signal form a main TRP, while other nodes simply transmit an altered version of the sensing signals. It may be recognized that aspects of the present application utilize, approximately, the same signaling overhead utilized by one-way time difference positioning procedures, but with benefits of eliminating synchronization error induced by the other nodes and the device for which location information is desired.

A further advantage of positioning procedures representative of aspects of the present application is operation in various environments. Aspects of the present application may be shown to operate effectively both in a line-of-sight-dominant environment and in a rich scattering environment.

An even further advantage of positioning procedures representative of aspects of the present application may be found in the availability and usability of aspects of the present application. Aspects of the present application may be shown to utilize different types of network nodes to work as positioning anchors. Typically, such nodes are available and willing to cooperate with the network. The location of one of such nodes is known when the node is a fixed node. The location of such nodes is easily tracked when such nodes are mobile nodes. Conveniently, aspects of the present application may be shown to enable given nodes to serve as positioning anchors, even when the given nodes have very limited capabilities, for example, in terms of power mode and processing. The given nodes serving as positioning anchors are merely asked to manipulate a signal in the RF domain. Accordingly, only very limited power resources and/or processing resources are asked for from the node.

An even further advantage of positioning procedures representative of aspects of the present application may be found in a compatibility with current systems. Indeed, aspects of the present application may be shown to be compatible with current cellular systems where aspects of the present application may be implemented through the application of simple modifications to cooperative signaling schemes that the current positioning methods utilize.

A still further advantage of positioning procedures representative of aspects of the present application is that, since the wireless links are not reliable due to high path-loss and blockage issues in high frequencies, aspects of the present application may be shown to enhance reliability by providing spatial diversity through the deployment and use of helping nodes.

According to an aspect of the present disclosure, there is provided a method for carrying out at a sensing receiver. The method includes receiving, at the sensing receiver and from a first transmit receive point (TRP) over a first direction, a first sensing signal, receiving, at the sensing receiver and from a helping node over a second direction, a second sensing signal, the second sensing signal based on the first sensing signal, obtaining, at the sensing receiver, multi-path measurement information, obtaining, at the sensing receiver from the multi-path measurement information, a first total delay for the first direction, obtaining, at the sensing receiver from the multi-path measurement information, a second total delay for the second direction and transmitting, from the sensing receiver to a network entity, feedback, the feedback obtained by processing the first total delay and the second total delay, the feedback allowing the network entity to determine a location for the sensing receiver.

According to an aspect of the present disclosure, there is provided a method for enhancing obtaining of measurements for use in positioning. The method includes receiving, at a first transmit receive point (TRP) and from a second TRP, a first sensing signal and transmitting, at the first TRP, a second sensing signal, the second sensing signal based on the first sensing signal.

According to an aspect of the present disclosure, there is provided a method, for carrying out at a first transmit receive point (TRP), of sensing elements of a wireless communication network. The method includes transmitting, to a second TRP, a sensing configuration parameter, transmitting a first sensing signal, receiving, from a user equipment (UE), feedback, the feedback obtained, by the UE, based on measurements of a received version of the first sensing signal and measurements of a received version of a second sensing signal, the second sensing signal based on the second TRP using the sensing configuration parameter to alter the first sensing signal and processing the feedback to determine a location for the UE relative to a location for the first TRP and a location for the second TRP.

According to an aspect of the present disclosure, there is provided a method for carrying out at a sensing receiver. The method includes receiving, at the sensing receiver, location information for first a transmit receive point (TRP) and a second TRP, receiving, at the sensing receiver and from the first TRP over a first direction, a first sensing signal, receiving, at the sensing receiver and from the second TRP over a second direction, a second sensing signal, the second sensing signal based on the first sensing signal, obtaining, at the sensing receiver, multi-path measurement information, obtaining, at the sensing receiver from the multi-path measurement information, a first total delay for the first direction, obtaining, at the sensing receiver from the multi-path measurement information, a second total delay for the second direction and processing, at the sensing receiver, the first total delay and the second total delay to determine, in view of the location information for the first TRP and the second TRP, a location for the sensing receiver.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates an example network that includes a main transmit receive point, a plurality of helper transmit receive points, a target user equipment and the sensing management function of FIG. 5;

FIG. 7 illustrates example steps in a method for carrying out at the main transmit receive point of FIG. 6, in accordance with aspects of the present application;

FIG. 8 illustrates example steps in a method for carrying out at a representative one of the helper transmit receive points of FIG. 6, in accordance with aspects of the present application;

FIG. 9 illustrates example steps in a method for carrying out at the target user equipment of FIG. 6, in accordance with aspects of the present application;

FIG. 10 illustrates, in a signal flow diagram, a flow of information, sensing signals and feedback among the elements of the example network of FIG. 6, in accordance with aspects of the present application; and

FIG. 11 illustrates configuration parameter pairs as a plot for elements of the example network of FIG. 6, in accordance with aspects of the present application.

### DETAILED DESCRIPTION OF THE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

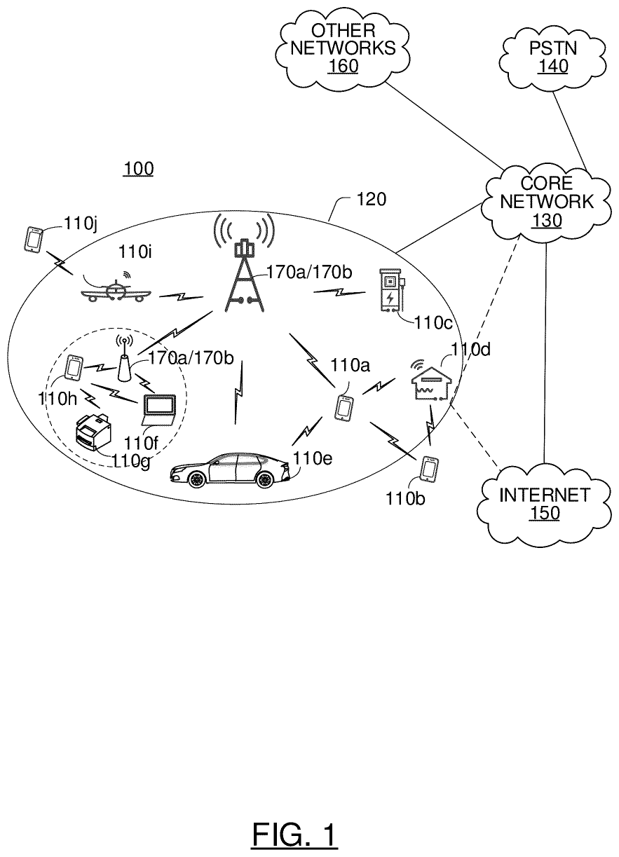

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

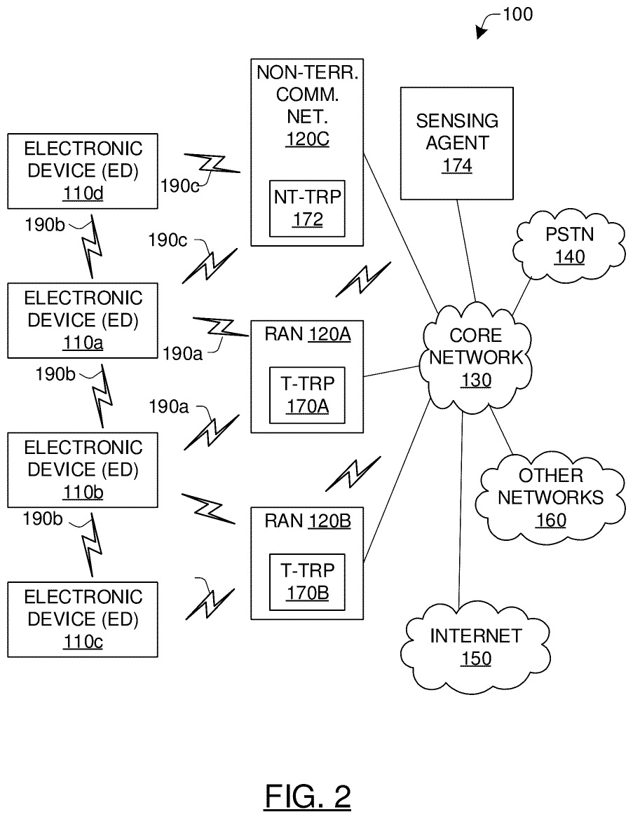

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

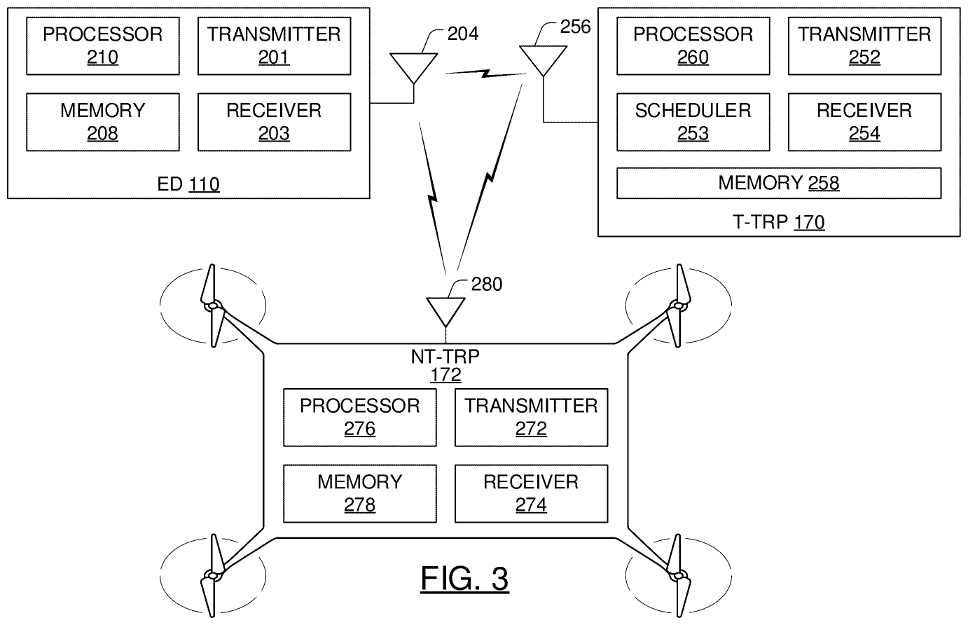

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random-access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high-altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

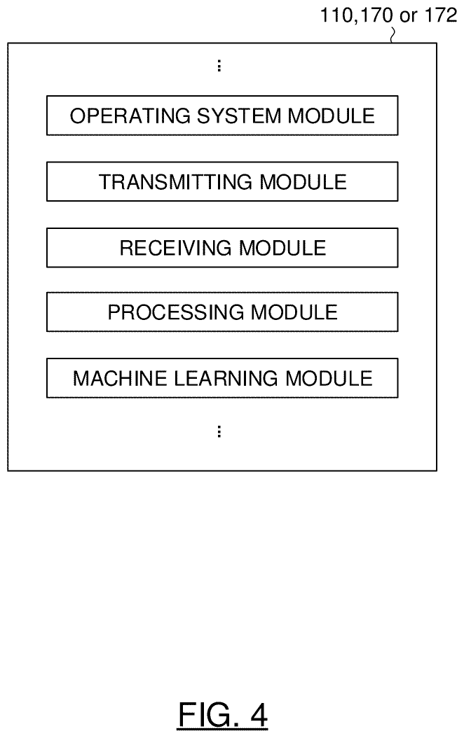

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE location information is often used in cellular communication networks to improve various performance metrics for the network. Such performance metrics may, for example, include capacity, agility and efficiency. The improvement may be achieved when elements of the network exploit the location, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. A sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

The sensing agent 174 may combine sensing-based techniques with reference signal-based techniques to enhance UE pose determination. This type of sensing agent 174 may also be known as a sensing management function (SMF) 176. In some networks, the SMF 176 may also be known as a location management function (LMF). The SMF 176 may be implemented as a physically independent entity located at the core network 130 with connection to the multiple BSs 170. In other aspects of the present application, the SMF 176 may be implemented as a logical entity co-located inside a BS 170 through logic carried out by the processor 260.

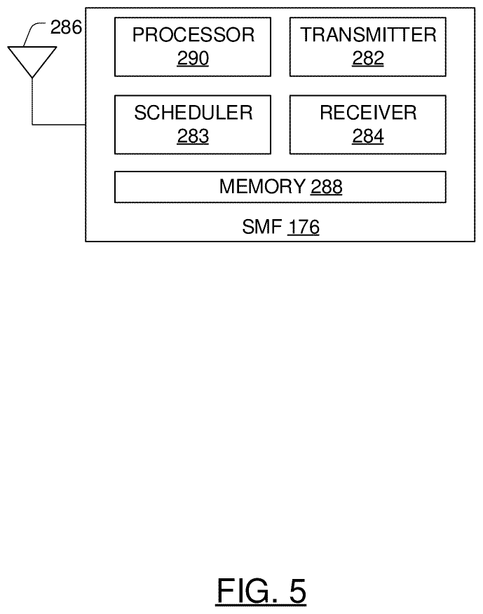

FIG. 5 illustrates an example SMF 176, implemented as a physically independent entity, that includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high-altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas is arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or an SSB resource identifier, or a sounding reference signal (SRS) resource identifier, or other reference signal resource identifier.

Across the different generations of cellular systems, it may be shown that a main goal for the positioning procedures is to significantly increase position resolution and accuracy.

Position resolution, i.e., the smallest position change that can be measured, may be shown to be governed by the main characteristics of the positioning signals, such as the known SRS and the known positioning reference signals (PRS). The main characteristics may be understood to include signal bandwidth, carrier frequency and number of antenna elements. It follows that significant position resolution enhancement may be acquired by enhancing the main characteristics. The approach of enhancing the main characteristics may be shown to be the approach typically implement in current cellular systems and proposed for next-generation cellular systems.

On the other hand, position accuracy, i.e., a measure of how close an estimated value of a parameter is to the true value of the parameter, may be shown to be closely tied to channel impairments and hardware impairments. A major parameter affecting the position accuracy is signal-to-noise ratio (SNR), which is related to the noise parameter. SNR may be included in both channel impairment and hardware impairment. Indeed, channel impairments and hardware impairments may be shown to induce measurement errors and relatively large position estimation biases. In particular, the relatively large position estimation biases may be shown to dramatically deteriorate position accuracy. Accordingly, relatively large biases may be shown to be the main limiting factor for achieving high position accuracy. Chief among these large position estimation biases is a bias related to time synchronization error. Positioning procedures, for determining a location of a target user equipment (UE), are known to rely upon a plurality of positioning anchor devices. Each of the positioning anchor devices is known to have an internal clock. Time synchronization error may be shown to be due to mismatches among the internal clocks in the plurality of positioning anchor devices. Time synchronization error may also be shown to be due to mismatches between a network reference clock and the internal clocks in the plurality of positioning anchor devices. Time synchronization error may further be shown to be due to a mismatch between the network reference clock and the internal clocks in the target UE.

It may be shown that time synchronization errors impact time-of-flight procedures and phase positioning procedures. Notably, time-of-flight procedures and phase positioning procedures are the majority of positioning procedures. It may be shown that finding a way to counter time synchronization error is critical for two reasons.

Firstly, a typical positioning procedure involves receiving/transmitting multiple synchronized PRS/SRS from/to multiple TRPs. Particularly, it may be shown to be beneficial that three or more TRPs are tightly synchronized.

Secondly, a slight error in time synchronization between anchor devices and the network, or between the target UE and the network, may be shown to translate into a relatively large position error. For instance, a 1 ns time synchronization error may be shown to lead to a roughly 30 cm position error. Various of the envisioned applications and use cases are known to only achieve their potential benefits in view of cm-level position accuracy. It may be shown that cm-level position accuracy may be achieved by reducing the time synchronization error to be below 0.1 ns at all terminals.

Unfortunately, achieving, in real-life, a reduction in the time synchronization error to below 0.1 ns at all terminals may be shown to be difficult and costly. Indeed, achieving a reduction to the sub-nano synchronization level may be shown to either involve equipping each terminal with an atomic clock or involve use of a large signaling overhead and delay between the TRPs and the target UE.

Known positioning procedures may be classified into a first category and a second category.

Positioning procedures in the first category reply on multiple TRPs to provide enough information, obtained by measurement of RF signals sent/received by these TRPs, to obtain UE position. A large class of positioning procedures in the first category are based on time measurement. These Positioning procedures utilize a known time differencing technique to eliminate time synchronization errors between the nodes. Known time differencing techniques are based on obtaining a difference between a certain time aspect (e.g., ToA/ToF) of two or more reference signals. By obtaining a difference, it may be shown that common time synchronization offsets of the used reference signals may be eliminated at one side (either the TX side or the RX side). To eliminate the time synchronization error at two sides, i.e., the TX side and the RX side (e.g., the UE side and the TRP side), two-way (at least) time differencing is known to be performed, at both sides, on a basis of two or more reference signals and related time measurements.

Positioning procedures in the first category are known to have drawbacks including a relatively large signaling overhead, between the cooperative TRPs and the target UE, and a relatively large delay/latency.

It may be that the signaling overhead and latency may be acceptable for the positioning procedures that utilize one-way time differencing techniques. Notably, the use of one-way time differencing techniques is known to involve increasing, by at least one, the number of anchor devices to be used as a reference anchor for the time differencing operations. For instance, the positioning procedure known as downlink time difference of arrival (DL-TDoA) utilizes at least three anchors to obtain two downlink reference signal time difference (DL-RSTD) measurements. The positioning procedure allows for determining a position for a target UE in the x-y plane. Notably, DL-TDoA may be shown to only eliminate the synchronization error added by the target UE.

On the other hand, two-way time differencing techniques are known to have much higher signaling overhead. Two-way time differencing techniques may be shown to involve sending at least two reference signals, one reference signal in the downlink direction and the other reference signal in the uplink direction, for each positioning anchor device or TRP. This directly leads to, at least, doubling the signaling overhead and resources for the positioning process. Additionally, sending at least two reference signals may be shown to intensify the latency of the positioning process. Sending at least two reference signals may be shown to, at least, double a propagation time (downlink, then uplink) and increase delay associated with taking measurements at the target UE and at each TRP. Additionally, time is associated with the task of collecting all these measurements. An example of the two-way time differencing techniques is the known multi-cell round trip time (RTT) positioning procedure.

Positioning procedures in the second category may be shown to depend on utilizing only a single TRP to, thereby, attempt to avoid the synchronization error that is known to be induced in the practice of using multiple TRPs as positioning anchors. However, for this category of positioning procedures, which may be called “non-cooperative single-TRP positioning procedures, it may be shown that depending only on a single TRP might provide insufficient information to determine the target UE location. Non-cooperative single-TRP positioning procedures may be understood to belong to a “class one” (TRP to UE direction) and a “class two” (UE to UE direction). Therefore, positioning procedures in the second category may, in class one, utilize the idea of attributing multi-path components of received reference signal to environment objects with known locations. Particularly, aspects (e.g., delay) of the resolved multi-path components, and the environment objects to which the multi-path components have been attributed, may be seen to work as virtual positioning anchor devices. In class two, a single TRP might implement a positioning procedure that utilizes capable UEs in the vicinity of the target UE to work as positioning anchor devices. These capable UEs are assumed to be in connected states with the network and transmit sensing signals to the target UE (or receive sensing signals from the target UE).

It may be considered that the main drawback of the class one non-cooperative single-TRP positioning procedures is that performance may be shown to significantly deteriorate in LoS-dominant environments, which are expected to be the mainstream environment model for next-generation cellular communication systems. More importantly, the class one non-cooperative single-TRP positioning procedures may be shown to involve building large dictionaries of objects in a given environment and it may be considered that there is a relatively high cost associated with maintaining these dictionaries up-to-date.

On the other hand, it may be considered that the main drawback of the class two non-cooperative single-TRP positioning procedures is that the capable UEs are connected to the network. Accordingly, it may be implicitly assumed that the capable UEs are synchronized with the network up to a certain level. However, typically, the level of synchronization achieved between the capable UEs and the network is understood to not be tolerable in the context of most of the envisioned positioning applications. For instance, the synchronization level that may be established for connected devices, from a communication perspective, may be shown to be around tens of nanoseconds. A synchronization level around tens of nanoseconds may be shown to result in positioning errors on the order of meters. Moreover, the mobility of the capable UEs may be addressed through provision of frequent position updates. It may be shown that it is challenging to utilize a mobile device as an anchor device.

Aspects of the present application relate to positioning procedures that strive to eliminate time synchronization error associated with a mismatch between the internal clocks of a plurality of cooperative TRPs (positioning anchor devices) while utilizing low overhead signaling schemes and enhancing the energy efficiency of the positioning process.

Aspects of the present application relate to allowing cooperation between TRPs/anchor devices in such a way as to create multiple copies of an original sensing signal transmitted from a main TRP (“mTRP”). The multiple copies are created as a consequence of each helping TRP (“hTRP”), among a plurality of hTRPs, creating a version of the original sensing signal by manipulating time-frequency-spatial properties of the original sensing signal using low-complexity and cheap RF operations. The generation of the copies of the original sensing signal may be facilitated by the sending of the original sensing signal from the mTRP to all hTRPs. The hTRPs may be understood to, generically, be network nodes. Example network nodes that are suitable for a role as an hTRP include a TRP from a neighbor cell, a network-controlled RF relay, a network-controlled repeater, a sensing-only TRP and an intelligent reflective surface (IRS). Upon receiving the original sensing signal, the hTRP may delay the original sensing signal in time and may shift the original sensing signal in frequency. The hTRP may then transmit the copied sensing signal toward the target UE. Since the time and frequency manipulations are only limited to pre-defined shifts in the RF domain, these manipulations do not change the original time reference or the frequency reference point of the sensing signal (i.e., the time and frequency references of the mTRP). The transmission between mTRPs and hTRPs may be accomplished through NR-integrated access and backhaul (IAB) links or regular access links.

Aspects of the present application may be shown to be applicable to be utilized in scenarios where high accuracy position information is desired for certain target UEs. These target UEs may be loosely synchronized with a network. Moreover, the simplicity of aspects of the present application and corresponding low processing requirements may be shown to allow widespread implementation and adoption in existing cellular communication systems. Further, aspects of the present application may be shown to allow network-wide positioning diversity, where measurements from extra hTRPs can be fused to gain reliability.

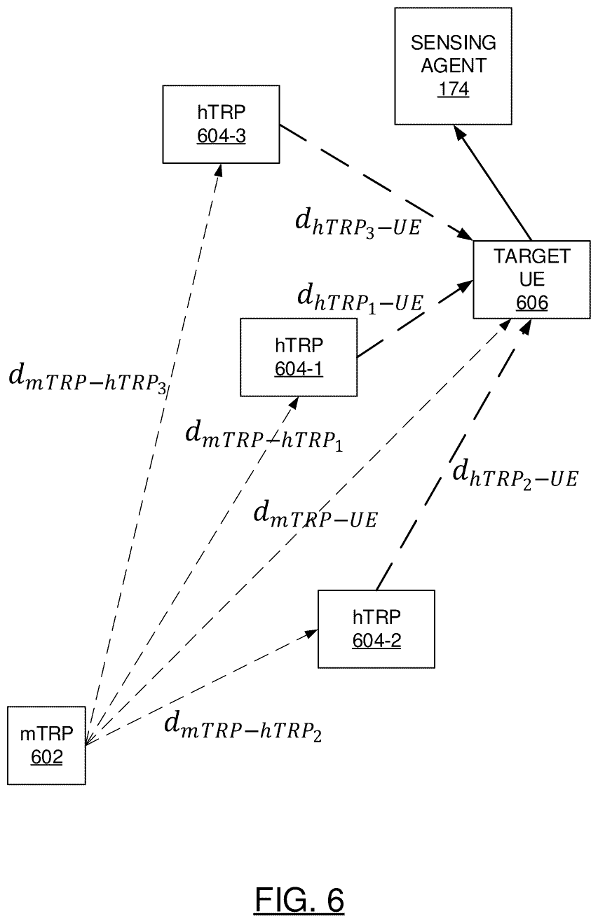

The four main nodes/terminals in aspects of the present application are illustrated in FIG. 6: an SMF; an mTRP; an hTRP; and a target UE. In particular, FIG. 6 illustrates an example network that includes an mTRP 602, a first hTRP 604-1, a second hTRP 604-2, a third hTRP 604-3, a target UE 606 and the SMF 176.

The SMF 176 may be implemented as a physical network entity (see FIG. 5) or a logical network entity. The SMF 176 may be shown to orchestrate positioning procedures representative of aspects of the present application. The logical network entity version of the SMF 176 may, for example, be implemented at the mTRP 602. The main duties of the SMF 176 include: managing time and frequency resources and configurations of positioning signals; sending positioning signal configurations and pre-defined time and frequency shifts for the mTRP 602 and the hTRPs 604; receiving measurement information from the target UE 606 in case of operating in network-based mode; and processing the measurement information to determine a location for the target UE 606 without synchronization error bias.

The mTRP 602 may be implemented as a network node that is able to transmit sensing signals according to a received configuration. The location of the mTRP 602 is known at the node that will determine the location of the target UE 606. The main duties of the mTRP 602 include: receiving parts of a configuration of sensing signal from the SMF 176; and transmitting, to the hTRPs 604, a sensing signal based on the configuration defined by the SMF 176.

The hTRP 604 may be implemented as a TRP from a neighbor cell, a network-controlled RF relay or repeater, a sensing-only TRP, an IRS, etc. The hTRP 604 is expected to be able to reliably receive, from the mTRP 602, a sensing signal and process and forward, to the target UE 606, an altered sensing signal. The location of the hTRP 604 is known at the node, either the mTRP 602 or the target UE 606, that will determine the location of the target UE 606. The main duties of hTRPs include: receiving parts of a configuration of a sensing signal; receiving, from the mTRP, processing and forwarding the sensing signal. The processing and forwarding of the sensing signal may be accomplished according to pre-defined shifts configured by the SMF 176.

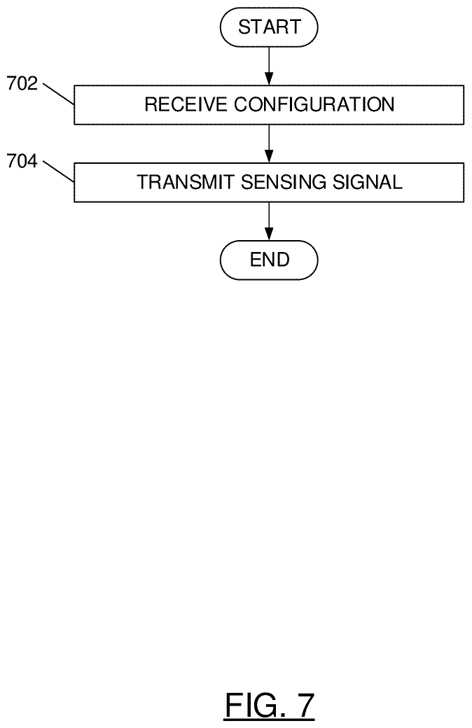

FIG. 7 illustrates example steps in a method for carrying out at the mTRP 602. Aspects of the present application are initiated by the mTRP 602 receiving (step 702), from the SMF 176, sensing signal configuration information. The mTRP 602 may then transmit (step 702) a sensing signal, s_{mTRP}(t). The sensing signal, s_{mTRP}(t), may, for one example, be a legacy PRS (e.g., the PRS signal for the DL-TDoA procedure in 5G systems). The sensing signal, s_{mTRP}(t), may, for another example, be a chirp-based reference signal. Notably, chirp-based reference signals are known to be heavily utilized in radar systems and sensing generally. A chirp-based reference signal may be implemented by time/frequency multiplexing multiple chirp signals. Each chirp signal may be expressed, mathematically, as x(t)=e^{j2πft+jπαt}^{²}, where the parameter f is referred to as the starting frequency and the parameter α is referred to as the chirp rate. In the context of FMCW, multiple chirp signals may be multiplexed in the time domain.

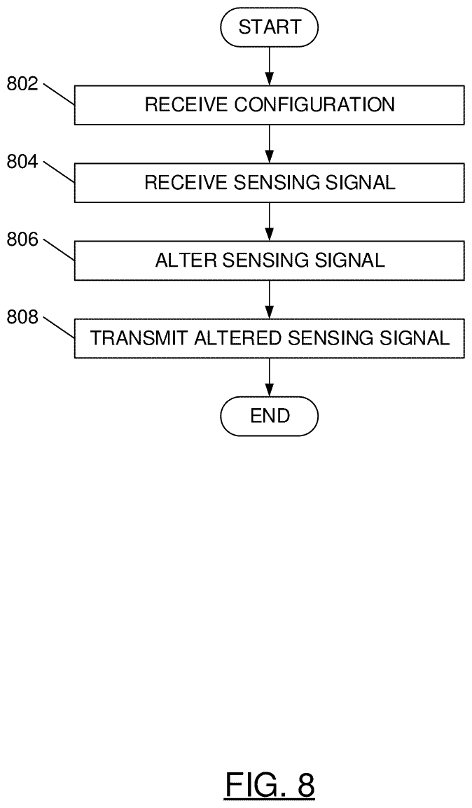

FIG. 8 illustrates example steps in a method for carrying out at a representative (i.e., an i^{th}) one of the hTRPs 604. Initially, the i^{th} hTRP receives (step 802), from the SMF 176, sensing signal configuration information. Upon receiving (step 804) the sensing signal, s_{mTRP}(t), the i^{th} hTRP alters (step 806) the sensing signal. Altering (step 806) the sensing signal may involve the i^{th} hTRP delaying the signal by an i^{th} delay, Tᵢ, shifting the frequency by an i^{th} shift, fᵢ, and/or applying an i^{th} beamforming vector, bᵢ(t). The i^{th} shift may be implemented using RF domain mixers. Notably, the i^{th} delay, Tᵢ, the i^{th} shift, fᵢ and the i^{th} beamforming vector, bᵢ(t), are node-specific parameters. These node-specific parameters may be configured by the SMF 176. The i^{th} hTRP may then transmit (step 808) the altered sensing signal. The altered sensing signal, s_{hTRP}_{ᵢ}(t), that is transmitted (step 808) by the i^{th} hTRP (hTRPᵢ) may be expressed as:

$${s}_{{hTRP}_{i}} ( t ) = {b}_{i} ( t ) {e}^{j 2 π {f}_{i} t} {s}_{R} ( t - {T}_{i} ) . \qquad ( 1 )$$

For design simplicity, the i^{th} delay, Tᵢ, may be set as a product of an i^{th} delay multiplier, nᵢ, and a base delay, T. That is, the i^{th} delay, Tᵢ, may be set as nᵢT. Similarly, the i^{th} shift, fᵢ, may be set as a product of an i^{th} shift multiplier, mᵢ, of a base shift, f. That is, the i^{th} shift, fᵢ, may be set as mᵢf. Accordingly, configuration parameters, received from the SMF 176, may be expressed as a configuration parameter pair, (nᵢ, mᵢ) or as a configuration parameter tuple, (nᵢ, mᵢ, bᵢ). It is noted that, ideally, the act of selecting the base delay, T, and the base shift, f, is performed in a way that avoids ambiguity in sensing signal detection.

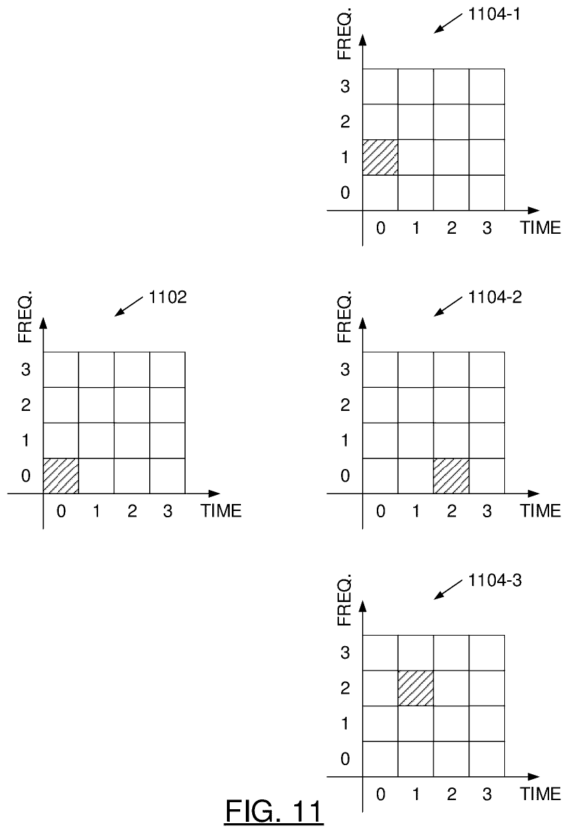

FIG. 11 illustrates the configuration parameter pairs, (nᵢ, mᵢ), as a plot for each node that include an intersection of a time slot indexed by the i^{th} delay multiplier, nᵢ, and a frequency slot indexed by the i^{th} shift multiplier, mᵢ. For a first example, FIG. 11 illustrates a main plot 1102 wherein the configuration parameter pairs for the mTRP 602 may be expressed as (0,0). For another example, FIG. 11 illustrates a first plot 1104-1 wherein the configuration parameter pairs for the first hTRP 604-1 may be expressed as (n₁, m₁)=(0,1). For a further example, FIG. 11 illustrates a second plot 1104-2 wherein the configuration parameter pairs for the second hTRP 604-2 may be expressed as (n₂, m₂)=(2,0). For an even further example, FIG. 11 illustrates a third plot 1104-3 wherein the configuration parameter pairs for the third hTRP 604-3 may be expressed as (n₃, m₃)=(1,2).

In some embodiments, such as where the mTRP 602 uses beamforming to transmit the sensing signal toward each hTRP, the sensing signal, s_{mTRP}(t), transmitted toward each hTRP might be made specific for the i^{th} hTRP, hTRPᵢ. For example, the mTRP 602 may transmit a specific sensing signal,

$${s}_{mTRP}^{( i )} ( t ) ,$$

wherein the superscript, i, is used to denote a correspondence to the hTRPᵢ. One way to realize a plurality of specific sensing signals would be to use different sequences or signals aimed toward each hTRP. For example, a linearly frequency modulated (LFM) sensing signal may be mathematically formulated, at the mTRP 602, as e^{j2πft+jπαt}^{²}. In this case, the LFM sensing signal parameters, (f, α), for a given hTRPᵢ can be chosen based on the ID of the given hTRPᵢ. This approach may be shown to further facilitate identifying the hTRPs at the UE based on the knowledge of a mapping between sensing signal parameters and hTRP ID. The mapping may be signaled to the UE through semi-static signaling, e.g., RRC or MAC-CE.

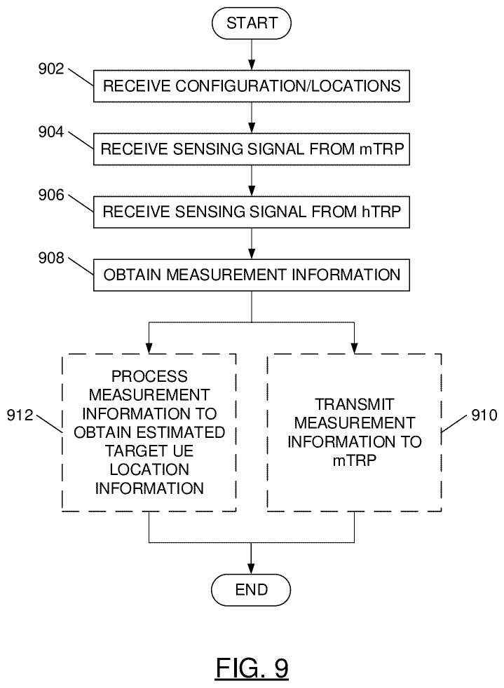

FIG. 9 illustrates example steps in a method for carrying out at the target UE 606. The target UE 606 may receive (step 902) configuration signaling including a record of locations of the hTRPs 604 and a mapping of configuration parameters to identities of the hTRPs 604. In operation, the target UE 606 receives (step 904), from the mTRP 602, the sensing signal, s_{mTRP}(t). Additionally, the target UE 606 receives (step 904), from each hTRP 604 among the plurality of hTRPs, an altered sensing signal, s_{hTRP}_{ᵢ}(t). Responsive to receiving (steps 904, 906) the sensing signals, the target UE 606 may obtain (step 908) multi-path measurement information for each sensing signal. The multi-path measurement information may include delay measurement information, angle of arrival (AoA) measurement information and Doppler measurement information. Notably, the sensing signals received in steps 904 and 906 may be shown to be separated widely in the frequency domain and in the time domain due to the time delay and frequency shift applied at the hTRPs 604. The target UE 606 may then transmit (step 910), to the SMF 176, the multi-path measurement information. Upon receiving the multi-path measurement information, the SMF 176 may process the multi-path measurement information, thereby obtaining location information for the target UE 606.

As an alternative to transmitting (step 910) the multi-path measurement information to the SMF 176 for processing, the target UE 606 may locally process (step 912) the multi-path measurement information to, thereby, obtain location information for the target UE 606. In particular, the target UE 606 may obtain, by processing (step 912) the multi-path measurement information, a list of active shift multipliers, {mᵢ}, i.e., a list of active frequency slots in which there is a signal transmitted from at least one hTRP 604, or a list of active delay multipliers, {nᵢ}, i.e., a list of active time slots in which there is a signal transmitted from at least one hTRP 604, based on which domain the signals are widely separated. By considering time of arrival measurements (i.e., performing a delay estimation), the target UE 606 may obtain a total delay of each direction, i (illustrated in FIG. 6). Indeed, each direction, i, may be understood to include a distance, d_{mTRP-hTRP}_{ᵢ}, from the mTRP 602 to the i^{th} hTRP (hTRPᵢ) 604-i and then a distance, d_{hTRP}_{ᵢ}_{-UE}, from the i^{th} hTRP (hTRPᵢ) 604-i to the target UE 606. The total delay, τᵢ, over the direction, i, may be expressed as:

$${τ}_{i} = T o {F}_{i} + {n}_{i} T + δ {t}_{u e} \qquad ( 2 )$$

where δtᵤₑ denotes a synchronization error between the target UE 606 and a reference network entity and the term ToFᵢ is representative of a time of flight of a signal over the direction, i. A value for the time of flight term, ToFᵢ, may be obtained by dividing the sum of the two distances by the speed of light, c, as follows, d_{mTRP-hTRP}_{₃}

$${τ}_{i} = \frac{{d}_{mTRP - {hTRP}_{i}} + {d}_{{hTRP}_{i} U E}}{c} + {n}_{i} T + δ {t}_{u e} . \qquad ( 3 )$$

The reference network entity may, for example, be the mTRP 602, in the case wherein the mTRP 602 is equipped with the SMF 176. It is notable that a timing offset/synchronization error between the mTRP 602 and each hTRP 604 does not appear in the equations. Indeed, synchronization error between the mTRP 602 and each hTRP 604 may be shown to cancel out. This cancelling out is mainly due to the delay manipulations and frequency manipulations at the hTRPs 604 being carried out in a manner that does not involve a change to the original time reference or frequency reference of the sensing signal transmitted by the mTRP 602.

In addition to receiving (step 906) sensing signals from each hTRP 604, it has been discussed hereinbefore that the target UE 606 may also receive (step 904) a sensing signal directly from the mTRP 602, over a distance, d_{mTRP-UE}, assuming line of sight exists between the mTRP 602 and the UE 606. A main delay, t, between transmission, at the mTRP 602, of the sensing signal and receipt, at the target UE 606, of the sensing signal may be expressed as:

$$τ = \frac{{d}_{mTRP - UE}}{c} + δ {t}_{u e} \qquad ( 4 )$$

The target UE 606 may determine an i^{th} difference, Δτᵢ, between a total delay, τᵢ, for the sensing signal received (step 906) from the i^{th} hTRP 604-i, and the main delay, τ, for the sensing signal received (step 904) from the mTRP 602,

$$Δ {τ}_{i} = {τ}_{i} - τ . \qquad ( 5 )$$

The i^{th} difference, Δτᵢ, may be referenced as a Time Difference of Arrival (TDoA) for the pair that includes the i^{th} hTRP 604-i and the mTRP 602. Equation (5) may be rewritten by substituting, into equation (5), the expression for total delay, τᵢ, from equation (3) and the expression for main delay, τ, from equation (4),

$$Δ {τ}_{i} = \frac{{d}_{mTRP - {hTRP}_{i}} + {d}_{{hTRP}_{i} UE}}{c} + {n}_{i} T + δ {t}_{u e} - ( \frac{{d}_{mTRP - UE}}{c} + δ {t}_{u e} ) . \qquad ( 6 )$$

It may be readily seen that the synchronization error, δtᵤₑ, cancels out, such that equation (6) simplifies to:

$$Δ {τ}_{i} = \frac{{d}_{mTRP - {hTRP}_{i}} + {d}_{{hTRP}_{i} UE}}{c} - \frac{{d}_{mTRP - UE}}{c} + {n}_{i} T . \qquad ( 7 )$$

It may be shown that estimation of the i^{th} delay term, nᵢT, may be facilitated by careful design of the base delay, T, such that T>>max(TDoA). Alternatively, it is notable that each pair of configuration parameters, (nᵢ, mᵢ), is unique to the i^{th} hTRP. Accordingly, upon processing a received sensing signal to determine the i^{th} shift, fᵢ, and, thereby, determining the shift multiplier, mᵢ, the delay multiplier, nᵢ, may be obtained as the other half of the pair of configuration parameters. It follows that an estimate of the i^{th} delay term, nᵢT, may then be obtained.

In some embodiments, where an LFM signal is used as sensing signal, the frequency shift can be translated to the time shift due to the unique property of this kind of signal. For example, if the transmitted signal is e^{jπαt}^{²} and the i^{th} hTRP uses a frequency shift −nᵢαT, the same equation (7) would follow even without any time shift at this hTRP. This way, only frequency shift can be implemented at the hTRPs. This is important as a frequency shift is much simpler to implement, in the RF domain, than a time shift.

Through receiving (step 902, FIG. 9) configuration signaling, the target UE 606 may have a record of locations of the hTRPs 604. The processing (step 912), by the target UE 606 to estimate its own location, of the multi-path measurement information may involve obtaining information about the identity of the hTRP 604, from which a particular sensing signal has been received, and using the identity of the hTRP 604 to obtain the record of the location of the hTRP 604. The target UE 606 may use the location of the hTRP 604 in view of the measurement information to estimate its own location. Knowledge of the location of the hTRP 604 (and knowledge of the location of the mTRP 602) helps the target UE 606 to obtain the term d_{mTRP-hTRP}_{ᵢ}. This term may be combined with the knowledge of nᵢ to give the difference term (d_{hTRP}_{ᵢ}_{-UE}−d_{mTRP-UE}) in equation (7). Having two of these equations (corresponding to two hTRPs) may be shown to allow the target UE 606 to estimate its own location. It follows, for situations in which the target UE 606 does not have a LOS to the mTRP 602, that three such equations, corresponding to three hTRPs, may be shown to allow the target UE 606 to estimate its own location. By combining the delay measurements with AoA measurements, the estimated target UE location information may be further enhanced. The processing (step 912), by the target UE 606, may involve the target UE 606: obtaining the total delay for the first direction; obtaining the total delay for the second direction; obtaining the node ID for the first hTRP; obtaining the node ID for the second helping node; obtaining, based on a look up table (LUT) shared with the target UE 606 (through semi-static signaling, e.g., RRC signaling by the mTRP 602 or the SMF 176) a location for the first hTRP 604-1; and obtaining, based on the LUT, a location for the second hTRP 604-2. Through the processing (step 912), the target UE 606 may obtain a partial delay between itself and the first hTRP 604-1 and a partial delay between itself and the second hTRP 604-2. Accordingly, the target UE 606 may obtain an estimate of its own location.

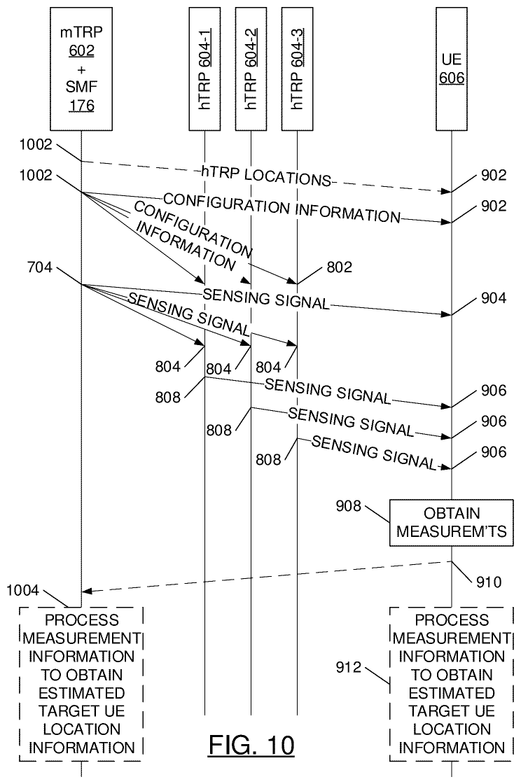

FIG. 10 illustrates, in a signal flow diagram, a flow of information, sensing signals and feedback associated with aspects of the present application. For the purposes of simplifying FIG. 10, it may be assumed that the mTRP 602 includes the SMF 176, which is configured to control and handle sensing resources for a group of TRPs. Accordingly, it may be understood that the signaling transmitted by, and feedback received by, the mTRP 602 in FIG. 10 is both for the mTRP 602 and for the SMF 176. Notably, the target UE 606, in FIG. 10, may be understood to represent an entity that may, more generically, be called a “sensing receiver.” That is, it should be clear that the entity that carries out the steps attributed herein to the target UE 606 may be carried out by a non-UE entity. The term sensing receiver is intended to encompass UEs and non-UE entities. Furthermore, the hTRPs 604 in FIG. 10 may be understood to represent entities that may, more generically, be called “helping nodes.” That is, it should be clear that the entities that carry out the steps attributed herein to the hTRPs 604 may be carried out by a non-TRP entities. The term helping node is intended to encompass hTRPs and non-TRP entities.

The signaling procedure starts as the SMF 176 transmits (step 1002), to the target UE 606 and to the hTRPs 604, sensing configuration parameters, including nᵢ, mᵢ, T, f and bᵢ(t). Note that if the SMF 176 is a logical entity, it may be considered inaccurate to indicate that the SMF 176 “transmits” the configurations. Instead, the configurations may be transmitted by a physical entity, such as the mTRP 602. Further notably, the signaling of configuration parameters to the hTRPs can be carried out through Xn signaling, since configuration transmission may be considered to be “backhaul signaling,” which is distinct from access signaling. The transmitting (step 1002) of the sensing configuration parameters may also include transmitting (step 1002) hTRP locations to the target UE 606. The transmitting (step 1002) may be accomplished using control signaling, e.g., RRC or MAC-CE. The target UE 606 receives (step 902, FIG. 9) the configuration signaling and may be shown to store the records of locations of the hTRPs 604. Furthermore, the hTRPs 604 receive (step 802), from the SMF 176, the sensing signal configuration information.

Subsequently, the mTRP 602 transmits (step 702, FIG. 7) the sensing signal according to the configuration defined by the SMF 176. Upon receiving (step 804, FIG. 8) the sensing signal, the hTRPs apply (step 804, FIG. 8) respective time delays and frequency shifts, according to the configuration defined by the SMF 176, to obtain an altered sensing signal. The hTRPs then transmit (step 806, FIG. 8) the altered sensing signal, s_{hTRP}_{ᵢ}(t), directly to the target UE 606. The target UE 606, upon receiving (step 906, FIG. 9) the altered sensing signals, obtains (step 908, FIG. 9) measurement information and processes (step 912, FIG. 9) the measurement information to obtain multi-path component parameters, e.g., delay measurement information, Doppler measurement information, angle of arrival measurement information.

Examples of the measurement information transmitted (step 910, FIG. 9), by the target UE 606 to the mTRP 602, have been discussed hereinbefore to include delay feedback and AoA feedback. Notably, the measurement information may include amplitude information for each link between a helping node (e.g., a hTRP 604) and a sensing receiver (e.g., the target UE 606). In some embodiments, the amplitude information for each helping-node-sensing-receiver pair may be in the form of a vector including the amplitude information corresponding to each channel multi-path component or virtual TP (vTP).

The term “virtual TP” may be understood to refer to an imaginary transmission point that is associated with a NLOS component that has been resolved and can be attributed to an environment object. The location of a vTP may be obtained based on mirroring the actual transmission point location, i.e., the mTRP 602 or the helping node 604, around the surface/plane of the environment object to which the vTP is attributed.

In this case, the delay (partial or total) feedback and the AoA feedback may also be configured in the same format, such that there is a correspondence between the amplitude-delay-AoA measurement information for each path of each helping-node-sensing-receiver pair. In some embodiments, amplitude information for each channel multi-path component of each helping-node-sensing-receiver pair can be in the format of absolute values, or one absolute value (e.g., related to LOS path) and multiple difference values relative to the absolute value. There might also be specified a threshold value (absolute or relative) for which the paths for each helping-node-sensing-receiver pair whose amplitude falls below this threshold value will not be reported. Moreover, in some embodiments, for the sake of alleviating the feedback overhead and depending on applications requirements (e.g., accuracy), the sensing receiver may be preconfigured to report the amplitude information for only a given number of the channel multipath components after quantizing them according to a preconfigured mapping/quantization function. The amplitude measurement at the sensing receiver can be in the form of RSRP measurement, which can be performed, for example, in the same manner as DL-PRS-RSRP measurements are performed. Based on the type of the positioning application, either network-based positioning or UE-assisted positioning, configured by the SMF 176, the target sensing receiver 606 either transmits (step 910, FIG. 9) the collected measurements to the SMF 176 to enable estimating its position at the SMF 176 or estimates, by processing (step 912, FIG. 9) measurement information, its own position by utilizing the assistance data (e.g., helping node locations) received from the SMF 176. Optionally, the target sensing receiver 606 may transmit, to the SMF 176, its self-estimated position. Notably, a feedback channel, for use by the target sensing receiver 606 to transmit (step 910, FIG. 9) the measurement information to the mTRP 602, may be specified in the configuration signaling received, in step 902, by the target sensing receiver 606. The configuration of whether the sensing receiver is expected to perform amplitude measurement and the format to report the amplitude measurements (and their associated delay and AoA measurements) can be signaled to the target sensing receiver 606 through higher layer signaling, e.g., RRC and MAC-CE. The signaling details may include indications of feedback format (# of paths, whether the feedback report is a vector or non-vector), feedback contents (amplitude-AoA-delay, amplitude-delay, delay-AoA, amplitude-AoA, or each individual parameter reported separately), quantization format and quantization levels for each parameter, and the threshold value. Additionally, the target sensing receiver 606 may be configured to report the measurements to the mTRP 602 or any other network TRP. This may be shown to be useful for sensing assisted communication or sensing assisted positioning applications.

It may be shown that the mTRP 602 may utilize the amplitude information, in conjunction with the corresponding AoA and delay information, to reconstruct the RF channel for each helping-node-sensing-receiver pair. In some embodiments, the amplitude information, in conjunction with the corresponding AoA information, can be used to estimate the channel subspace for each helping-node-sensing-receiver pair. This information can be used for the SMF 176 to construct or update the TRP-location RF channel dictionary or TRP-location RF channel subspace dictionary. The RF channel (or channel subspace) dictionary may include the mapping between a location and the amplitude-delay-AoA information (or the mapping between a location and the amplitude-AoA information) for each channel path measured on that location for each helping-node-sensing-receiver pair. In the case the location is measured at the target sensing receiver 606, the location information may be shared with the SMF 176, along with the amplitude-delay-AoA information. This dictionary may be stored in the SMF 176 and part of it may be signaled to the target sensing receiver 606, based on the approximate prior knowledge of its location. Notably, this channel dictionary can be utilized to enhance the performance of other communication procedures between the sensing receiver, main TRP and helping nodes.

In another aspect of the present application, which aspect may be referred to as a UE-assisted positioning procedure, the target UE 606 may estimate (step 912, FIG. 9) its own location. The UE-assisted positioning procedure is facilitated by the SMF 176 transmitting (step 1002) locations of the hTRPs 604 to the target UE 606. The locations are received, by the target UE 606, in step 902 (see FIG. 9).

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving, at a sensing receiver and from a first transmit receive point (TRP) over a first direction, a first sensing signal;
receiving, at the sensing receiver and from a first node over a second direction, a second sensing signal, the second sensing signal being based on the first sensing signal;
obtaining, at the sensing receiver, multi-path measurement information based on the first sensing signal and the second sensing signal;
obtaining, at the sensing receiver from the multi-path measurement information, a first total delay for the first direction;
obtaining, at the sensing receiver from the multi-path measurement information, a second total delay for the second direction; and
transmitting, from the sensing receiver to a network entity, feedback, the feedback obtained by processing the first total delay and the second total delay, and the feedback allowing the network entity to determine a location for the sensing receiver.

2. The method of claim 1, wherein the multi-path measurement information comprises a first angle of arrival of the first sensing signal.

3. The method of claim 2, wherein the multi-path measurement information comprises a second angle of arrival of the second sensing signal.

4. The method of claim 1, further comprising receiving a plurality of sensing configuration parameters specific to the first node.

5. The method of claim 4, wherein the plurality of sensing configuration parameters comprises an indication of a degree to which the first node is to shift the first sensing signal in frequency.

6. A method comprising:
receiving, at a first node and from a first transmit receive point (TRP), a first sensing signal; and
transmitting, at the first node, a second sensing signal, the second sensing signal being based on the first sensing signal.

7. The method of claim 6, further comprising receiving sensing configuration parameters specific to the first node.

8. The method of claim 7, wherein the second sensing signal comprises the first sensing signal shifted in frequency.

9. The method of claim 8, wherein the sensing configuration parameters comprise a base frequency parameter.

10. The method of claim 8, wherein the sensing configuration parameters comprise a frequency shift parameter specific to the first node.

11. An apparatus, comprising:
at least one processor; and
memory storing instructions, wherein when the instructions are executed by the at least one processor, the apparatus is caused to perform operations comprising:
receiving, over a first direction, a first sensing signal;
receiving, over a second direction, a second sensing signal, the second sensing signal being based on the first sensing signal;
obtaining multi-path measurement information based on the first sensing signal and the second sensing signal;
obtaining, from the multi-path measurement information, a first total delay for the first direction;
obtaining, from the multi-path measurement information, a second total delay for the second direction; and
transmitting feedback, the feedback obtained by processing the first total delay and the second total delay, and the feedback allowing a network entity to determine a location for the apparatus.

12. The apparatus of claim 11, wherein the multi-path measurement information comprises a first angle of arrival of the first sensing signal.

13. The apparatus of claim 12, wherein the multi-path measurement information comprises a second angle of arrival of the second sensing signal.

14. The apparatus of claim 11, further comprising receiving a plurality of sensing configuration parameters specific to a first node.

15. The apparatus of claim 14, wherein the plurality of sensing configuration parameters comprises an indication of a degree to which the first node is to shift the first sensing signal in frequency.

16. An apparatus, comprising:
at least one processor; and
memory storing instructions, wherein when the instructions are executed by the processor, the apparatus is caused to perform operations comprising:
receiving a first sensing signal; and
transmitting a second sensing signal, the second sensing signal being based on the first sensing signal.

17. The apparatus of claim 16, further comprising receiving sensing configuration parameters specific to a first node.

18. The apparatus of claim 17, wherein the second sensing signal comprises the first sensing signal shifted in frequency.

19. The apparatus of claim 18, wherein the sensing configuration parameters comprise a base frequency parameter.

20. The apparatus of claim 18, wherein the sensing configuration parameters comprise a frequency shift parameter specific to the first node.
